(19) United States
(12) Patent Application Publication
(10) Pub. No.: US 2007/0023573 A1
(43) Pub. Date: Feb. 1, 2007

(54) Aircraft wing

(76) Inventors: Lee Robert Neale, Melbourne (AU); Alan Quayle, Bristol (GB); Eric Stephen Wood, Swindon (GB)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/201,739

(22) Filed: Aug. 11, 2005

(30) Foreign Application Priority Data
Aug. 18, 2004 (GB) 0418487.5

(51) Int. Cl. B64C 3/00

(52) U.S. Cl. 244/124

(57) ABSTRACT

An aircraft wing that may be used in large transport aircraft comprising a first wing portion that, in use, forms an inner portion of an aircraft wing, and is attached to a readily replaceable second wing portion comprising a wingtip. The second wing portion may be readily replaceable by a third wing portion comprising a wingtip, the third wing portion having a different functionality from the second wing portion.

### FIELD OF THE INVENTION

The present invention relates to wings for use in aircraft.

### BACKGROUND OF THE INVENTION

Many aircraft carry equipment, such as radar and sensing equipment, on the outside of the aircraft. Such equipment is often expensive and therefore it is desirable to fit it to aircraft as and when needed, rather than fit the equipment to all aircraft that could conceivably require the functionality afforded by such equipment. The equipment may conveniently be located in an aerodynamic pod, which is typically located on the wing of the aircraft. Such pods have the advantage of being able to be fitted as and when required. However, there are many disadvantages with using such pods; they increase aerodynamic drag and the weight of the aircraft, and present a point of attachment between the pod and the wing that may be prone to stress and fatigue. Attempts have been made to design aircraft with extra space for the location of such equipment inside the aircraft but this decreases space available for other equipment and fuel.

### SUMMARY OF THE INVENTION

The present invention aims to reduce or overcome the above-mentioned problems associated with the aircraft of the prior art.

In accordance with the present invention, there is provided an aircraft wing comprising:

(i) a first wing portion that, in use, forms an inner portion of an aircraft wing, and is attached to

(ii) a readily replaceable second wing portion comprising a wingtip.

This provides a readily replaceable wingtip, permitting the rapid replacement of a damaged wingtip or the replacement of a wingtip having a first functionality with a second wingtip with a different functionality.

“Readily replaceable” is intended to refer to a second wing portion that is intended to be routinely replaceable. The replacement would generally be relatively rapid compared to the time that it would take to replace a wingtip of a conventional aircraft in accordance with the prior art (explained in further detail below). It is preferred that replacement may be performed without significant damage to the components structural (and possibly all components) of the wing such that these components may be reused.

The conventional wing arrangement of an aircraft comprises a wingtip attached to the remainder of the wing using one or more metal plates or buttstraps. A liquid aerodynamic filler is introduced between the wingtip and the inner portion of the wing to form a seal. This filler typically dries over a period of about 24 hours and the aircraft is effectively grounded for this time. Furthermore, the buttstraps are prone to damage from abusive assembly in the field and packing is usually needed between the buttstrap and the cover of the wing in order to achieve satisfactory attachment. If one wished to remove the wingtip and reattach the same or another wingtip, then this would require removal of the filler from the wingtip and inner portion of the wing and the introduction of a fresh charge of liquid filler after reattachment of a wingtip to the inner portion of the wing.

Thus, the conventional wingtip arrangement is difficult to assemble, remove and reassemble over a short period of time and, as a result, an aircraft may be non-operational for a long period if one were to replace the wingtip in the conventional manner. Furthermore, such a wing structure does not readily allow replacement of the wingtip with a wingtip of a different functionality (for example, a wingtip carrying components of a radar system or sensing equipment, such as temperature sensors and air pressure sensors).

The wing of the present invention may be so arranged that the second wing portion is readily replaceable by a third wing portion comprising a wingtip, the third wing portion having a different functionality from the second wing portion. This allows an aircraft to be changed from a first configuration with the first and second wing portions for performing a first function (such as a standard aircraft) to a second configuration with the first and third wing portions for performing a second different function (such as research or monitoring aircraft, the third wing portion defining the wingtip comprising appropriate sensors, for example).

The functionality of at least one of the second and the third wing portion may be provided by one or more components contained within said at least one of the second and the third wing portion.

One or each of the first, second and if provided, third wing portions may comprise an upper wingskin and a lower wingskin. The or each wing portion comprising an upper wingskin and a lower wingskin may be further provided with a wingskin support member disposed between said upper and lower wingskins. All of the wing portions may be provided with a wingskin support member between said upper and lower wingskins. This facilitates support of the wingskins and may facilitate attachment of the first wing portion to another, for example the second wing portion. A joint may be formed by at least one fastener acting between the first wing portion wingskin support member and the second wing portion wingskin support member. This allows simple and effective replacement of the second wing portion.

One or both of the first and second wing portions may be provided with a seal member which, on attachment of the first wing portion to the second wing portion, forms a seal between said first and second wing portions. The seal member allows a usable seal to be formed very quickly between the two portions of wing. This permits quick replacement of wingtips and hence decreases the amount of time that an aircraft is non-operational. The seal member may be positioned to form a smooth aerodynamic interface between the first and second wing portions. The seal member may be provided with formations, for example, spigots, that may engage with corresponding formations, for example, corresponding apertures in the first or second wing portion. Such formations allow for the simple positioning of the seal member and help prevent unwanted parting of the seal member from the first or second wing portion when the first and second wing portions are parted.

The seal member may comprise any suitable material, such as silicone rubber, that does not readily perish in use. The seal member may be reusable. Alternatively, the seal member may be configured to be used once only. The seal member is advantageously preformed before being placed into contact with either wing portion.

The first wing portion may be attached to the second wing portion by a plurality of readily releasable fasteners. This allows satisfactory and safe attachment during use, while permitting rapid removal of the wingtip. If the aircraft wing comprises first and second wing portion wingskin support members, then the plurality of fasteners may be disposed around a periphery of at least one of the said support members.

An end of at least one of said fasteners may be captured within an enclosure of one of the support members. The said enclosure may be defined by a tunnel formed in said support member. The tunnel allows access to the said fastener preferably from within the interior space defined by the wing portion. The said support member may be a support member of the first wing portion.

One or both of the first and second wing portions may be provided with a removable cover to allow access to the area of attachment between the first and second wing portions. This facilitates access for a person removing and replacing a wingtip. For example, the removable cover may be provided in, and preferably as part of, the lower wingskin of the second wing portion.

At least one spigot may be provided to locate the first wing portion with respect to the second wing portion. This provides an easy and effective mechanism for relative position of the first and second wing portions.

The first wing portion wingskin support member may comprise an outer wing rib of the first wing portion. The outer wing rib may be positioned with a rib foot directed in a direction substantially opposite to a rib foot provided on at least one other inner wing rib of the first wing portion. This “reversed rib” geometry provides an effective mechanism for the attachment of a replaceable wingtip. The second wing portion wingskin support member may comprise a peripheral flange adapted to receive at least one said fastener. This arrangement allows the peripheral flange and the outer wing rib to be connected together.

The first wing portion may be provided with at least one electrical connector for forming an electrical connection with a corresponding connector in the second or third wing portion. This allows electrical connections to be formed and/or broken quickly between the inner and outer parts of the wing.

There is further provided a wing portion suitable for use as the first wing portion of the aircraft wing in accordance with the present invention.

There is further provided a wing portion suitable for use as the second wing portion of the aircraft wing in accordance with the present invention.

The first and second wing portions may comprise those features described with reference to the aircraft wing of the present invention. For example, the wing portion suitable for use as either the first or second wing portion of the aircraft wing may comprise a seal member, which, on attachment of the first wing portion to the second wing portion, forms a seal between said first and second wing portions.

There is further provided a kit of aircraft parts comprising

(i) a first wing portion that, in use, forms an inner portion of an aircraft wing, and

(ii) a second wing portion comprising a wingtip, the second wing portion being readily attachable to, and readily releasable from, the first wing portion.

This provides a readily replaceable wingtip.

The kit may further comprise a third wing portion comprising a wingtip, the third wing portion being readily attachable to the first wing portion.

This allows the second wing portion to be readily replaced by the third wing portion, for example, if the second wing portion becomes damaged or needs to be replaced by a wingtip having a different functionality.

The third wing portion advantageously has a different functionality from the second wing portion. This allows the second wing portion to be readily replaced by the third wing portion, for example, when the aircraft is to have a different configuration (for example, changing between a standard configuration and a research or monitoring configuration).

The first, second and third wing portions may comprise those features described with reference to the aircraft wing of the present invention. For example, the kit may comprise a seal member, which, on attachment of the first wing portion to the second wing portion, forms a seal between said first and second wing portions. Also, the functionality of at least one of the second and the third wing portion may be provided by one or more components contained within said at least one of the second and the third wing portion.

There is further provided a method of replacing a wingtip including the following steps:
(a) providing an aircraft wing comprising:

(i) a first wing portion that, in use, forms an inner portion of an aircraft wing, and is attached to

(ii) a readily replaceable second wing portion comprising a wingtip, wherein the wing is arranged so that the second wing portion is readily replaceable by a third wing portion comprising a wingtip, and

(iii) the third wing portion having a different functionality from the second wing portion,
(b) detaching the second wing portion,
(c) securing the third wing portion to the first wing portion.

This provides a simple and effective method for the replacement of a first wingtip by a second wingtip of differing functionality.

One or both of the first and second wing portions may be provided with a seal member which, on attachment of the first wing portion to the second wing portion, forms a seal between said first and second wing portions. The method may further comprise (after step (b)) the step of arranging the first and third wing portions and the seal member so that the seal member is sandwiched between the first and third wing portions.

In step (a), the first wing portion may be attached to the second wing portion by a plurality of readily releasable fasteners. The method may further comprise the step of releasing the readily releasable fasteners prior to step (b). Step (c) may comprise fastening the readily releasable fasteners.

The wing portions described above may comprise those features described with reference to the aircraft wing in accordance with the present invention.

For example, if the first wing portion comprises an electrical connector for forming an electrical connection with a corresponding electrical connector provided on the second or third wing portion, then the method may further comprise disconnecting the said electrical connector from the said corresponding connector provided by the second wing portion prior to detaching the second wing portion, and/or connecting the said electrical connector to the corresponding electrical connector provided by the third wing portion.

The present invention has particular application to large aircraft, such as large transport aircraft and particularly to aircraft that are used in applications other than civil aviation. The aircraft may be arranged to be operated by means of an onboard pilot.

### DESCRIPTION OF THE FIGURES

The present invention is now described by way of example only, with reference to the following figures, of which:

FIG. 1 is a perspective view of a part of a wing in accordance with the present invention;

FIG. 2 is a perspective view of a rib that is incorporated into a first wing portion of the wing of FIG. 1;

FIG. 3 is a schematic cross-section of the upper portion of the wing of FIG. 1; and

FIG. 4 is a plan view of an aircraft including the part of the wing shown in FIG. 1.

### DETAILED DESCRIPTION OF THE DRAWINGS

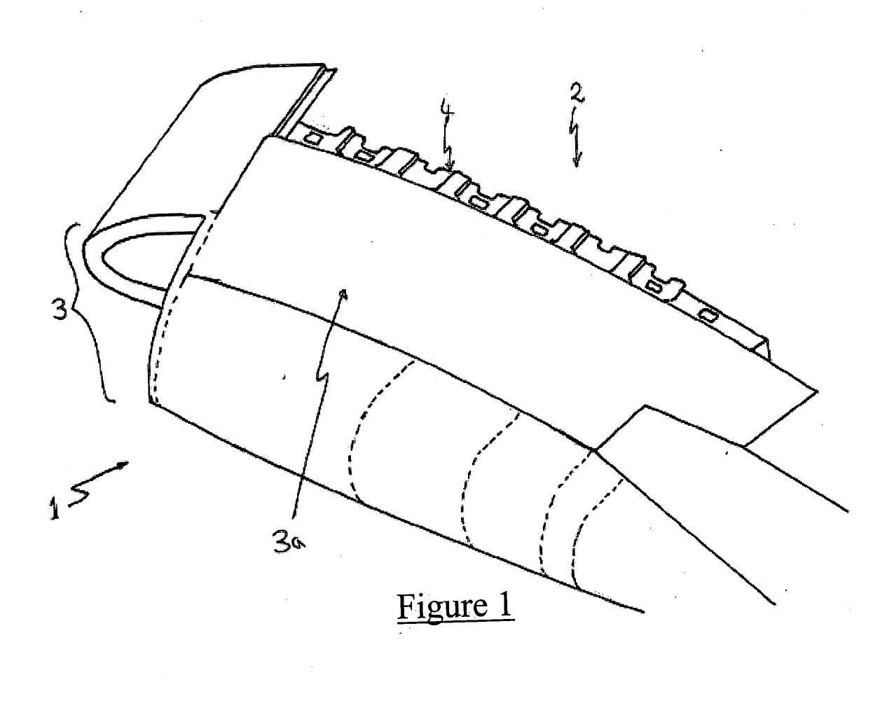

FIG. 1 shows part of the end of a wing in accordance with the present invention, the wing 1 comprising a first (inner) wing portion 2 to which is replaceably attached a second (outer) wing portion 3 comprising a wingtip. The upper wingskin has been omitted from the first wing portion 2 for clarity. Briefly, the first wing portion 2 is provided with an outer rib 4 to which the flange of a second wing portion 3 is attached by a series of releasable fasteners. Attachment of a flange to a rib allows the second wing portion 3 to be readily removed from the first wing portion 2 and readily replaced, for example, by an outer wing portion of a different functionality. It is possible, by means of this construction, to replace a wingtip easily in less than 4 hours and possibly in less than 1 hour.

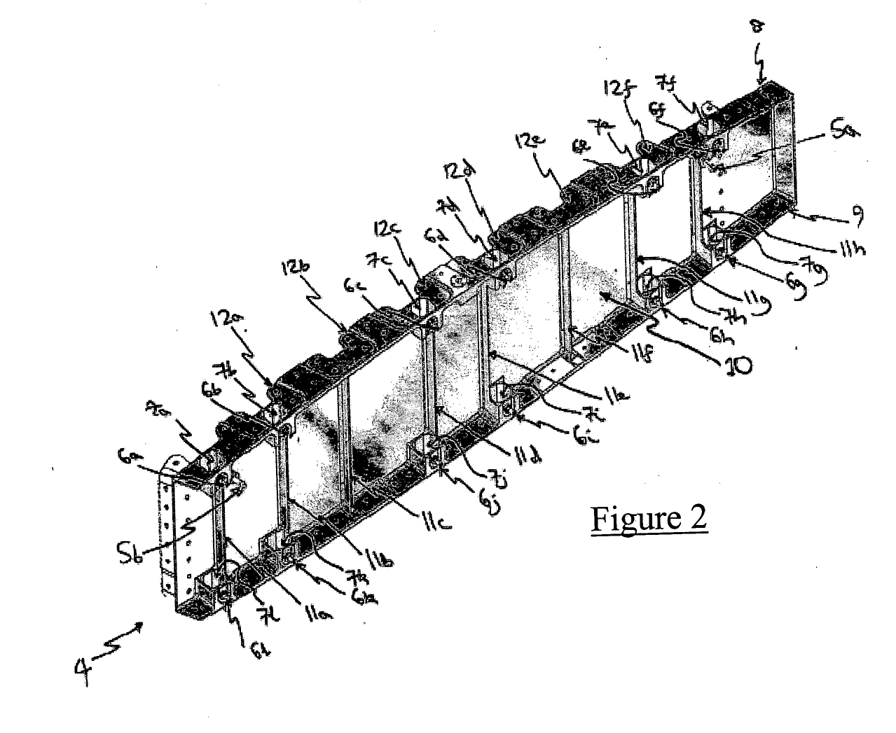

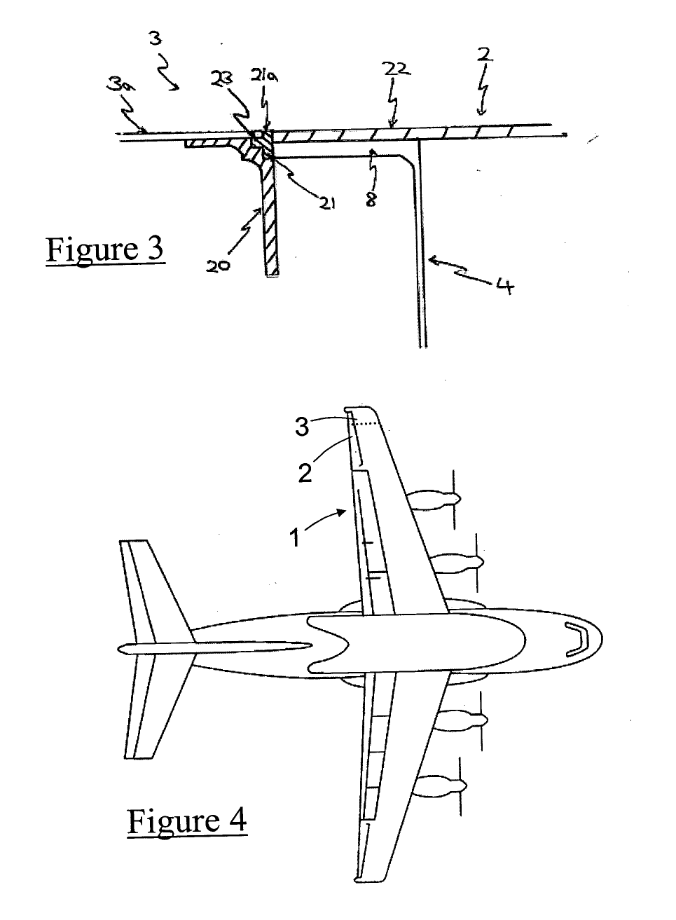

The connecting arrangement between the first 2 and second 3 wing portions will now be described in more detail with reference to FIGS. 2 and 3. Referring to FIG. 2, the rib 4, which provides support for the upper and lower wingskins (not visible) of the first wing portion 2, comprises a plate 10 that extends between an upper arcuate flange 8 and a lower arcuate flange 9. The plate 10 is provided with support struts 11a-11g that extend between the arcuate flanges 8, 9. The upper and lower wingskins are directly attached to the upper and lower arcuate flanges 8, 9, respectively, and thus the shape of the arcuate flanges 8, 9 determines the cross-sectional shape of the wing at the rib 4. For example, referring to FIG. 3, the upper wingskin in the form of an upper outer panel 22 of the first wing portion 2 is attached to the upper surface of arcuate flange 8.

Referring again to FIG. 2, stringer recesses 12a-f are formed in the upper surface of arcuate flange 8. Stringers may then be attached to the rib 4 via the apertures formed in the flange 8 in the region of the stringer recesses 12a-f without the need for sealing plates which are conventionally used to cover the stringers at their attachment points to a rib. Corresponding stringer recesses (not visible) are found in arcuate flange 9. Spigots 5a, 5b are provided near to the upper arcuate flange 8 at the front and rear ends, respectively, of the rib 4 in order to enable location of the second wing portion 3 with respect to the first wing portion 2. Fasteners 6a-l are provided along the length of both the upper and lower arcuate flanges 8, 9 to facilitate attachment of the rib 4 to the second wing portion 3. The fasteners 6a-l are screw fasteners, each threaded to engage with a correspondingly threaded bore in the second wing portion 3. Each fastener 6a-l is located so that access may be gained from inside or outside of the wing (once any wingskin or covering is removed). Each fastener 6a-l is located in a corresponding tunnel 7a-l which extends from the upper surface of the corresponding arcuate flange 8, 9 to the interior of the wing (when the rib 4 is in place). The lower part of the second wing portion 3 is provided with a removable cover (not shown). This cover allows access to the interior of the wing in the region of the second wing portion 3; specifically it allows access to the fasteners 6a-l which allows the second wing portion 3 to be readily removed from the first wing portion 2. This then allows a further wing portion to be mounted onto the first wing portion 2. The replacement wing portion may have the same functionality as the second wing portion 3 or may have a different functionality. For example, the replacement wing portion may contain sensing equipment, such as temperature sensors, air pressure sensors and radio receivers, thus allowing a standard aircraft to be transformed into a research or monitoring aircraft, merely by replacing a wingtip. Furthermore, replacement of the wingtip is very rapid.

The attachment of the second wing portion 3 to the rib 4 is shown in more detail in FIG. 3. The second wing portion 3 comprises a mounting flange 20 that is attached to a centrebox panel 3a, which forms the upper surface of the central part of the wingskin of the second wing portion 3. The mounting flange 20 extends around the periphery of the end of the second wing portion so that the mounting flange 20 may abut onto the arcuate flanges 8, 9 of the rib 4. Upper and lower wingskins are attached to the mounting flange 20. Only the upper wingskin, in the form of a wingtip centrebox panel 3a, is shown in FIG. 3. In order to fasten the first wing portion 2 to the second wing portion 3, each of the fasteners 6a-l extends from the rib 4 into a corresponding threaded aperture (not visible) provided in the mounting flange 20. A seal member 21, which extends circumferentially around the perimeter of the mounting flange 20, is provided at the end of the second wing portion 3 that abuts against the first wing portion 2. The seal member 21 is shaped so as to form a seal between the end of the first wing portion 2 as defined by the rib 4 and the upper outer panel 22, and the end of the second wing portion 3 as defined by the mounting flange 20 and the centrebox panel 3a. The seal member 21 is designed so that when the first and second wing portions 2, 3 are mutually attached ready for use, the outer surface 21a of the seal member 21 is flush with the centrebox panel 3a and upper outer panel 22. This requires that when the fasteners 6a-l are not in a fully tightened state, then the outer surface 21a of the seal member 21 is sub-flush with the centrebox panel 3a and the upper outer panel 22. The seal member 21 is provided with a projection 23 that extends around the circumference of the seal member 21, the projection locating in a corresponding groove in the mounting flange 20.

FIG. 4 shows an aircraft having a wing 1 incorporating the first (inner) wing portion 2 and the replaceably attached second (outer) wing portion 3 of FIG. 1. The aircraft is a large military transport aircraft and is about 40 metres long, has a wing span of about 40 metres and has an empty operating weight of about 70 tonnes.

A method of replacing a wingtip is now described with reference to FIGS. 1, 2 and 3. The cover is removed from the lower wingskin of the second wing portion 2, giving access to the interior of the second wing portion 2. Electrical connectors (not visible) associated with the first wing portion 2 are disengaged from electrical connectors (not visible) provided by second wing portion 3. Access to the fasteners 6a-l is provided by tunnels 7a-l. The fasteners 6a-l are loosened and the mounting flange 20 disengaged from the spigots 5a, 5b provided on the rib 4, thus allowing removal of the second wing portion 3 from the first wing portion 2. The second wing portion 3 of the wing 1 may then be replaced by a different wingtip portion. To do this, the sealing member 21 may then be removed from the mounting flange 20 and located onto the mounting flange 20 of the replacement wingtip portion. The replacement wingtip portion would then be introduced to the first wingtip portion 2, with the spigots 5a, 5b being located in apertures provided in the replacement wing portion. Fasteners 6a-l would then be operated to secure the replacement wingtip portion to the first wing portion 2. The electrical connectors associated with the first wing portion 1 are then reconnected with electrical connectors (not visible) provided by the replacement wingtip portion.

The seal member 21 may be replaced by a different seal member, for example, if the seal member 21 has failed or is due for replacement in accordance with servicing or other requirements.

The second wing portion 3 may be reattached to the first wing portion 1 subsequent to its removal.

In place of, or in addition to the projection 23, the seal member 21 may be provided with a plurality of moulded spigots, each of which penetrates an aperture in the mounting flange 20. Such an arrangement helps in the positioning of the seal member 21. The seal member may be moulded from silicone rubber or any other suitable material.

Whilst the present invention has been described and illustrated with reference to a particular embodiment, it will be appreciated by those of ordinary skill in the art that the invention lends itself to many different variations not specifically illustrated herein. For that reason, reference should be made to the claims for determining the true scope of the present invention. By way of example, certain variations to the above-described embodiments will now be described.

Those skilled in the art will realise that it is not essential to use a rib in order to provide a wing in accordance with the present invention. A rib provides a convenient structure to which a replaceable wingtip may be attached.

The fasteners 6a-l may be any type of conventional fastener capable of forming a sufficiently strong attachment between the first and second wing portions, such as nut and bolt.

1. A method of changing the functionality of an aircraft including the following steps:
(a) providing an aircraft having a wing comprising
(i) a first wing portion that, in use, forms an inner portion of an aircraft wing, and is attached to
(ii) a readily replaceable second wing portion comprising a wingtip,
(b) providing a third wing portion comprising a wingtip,
(c) detaching the second wing portion; and
(d) securing the third wing portion to the first wing portion, wherein the third wing portion has a different functionality from the second wing portion, and
the functionality of at least one of the second wing portion and the third wing portion is provided by one or more components contained within said at least one of the second wing portion and the third wing portion.

2. A method according to claim 1 wherein each wing portion comprises an upper wingskin and a lower wingskin and is provided with a wingskin support member disposed between said upper and lower wingskins.

3. A method according to claim 2 wherein
the step of detaching the second wing portion is conducted by unfastening at least one fastener acting between a wingskin support member of the first wing portion and a wingskin support member of the second wing portion and
the step of securing the third wing portion to the first wing portion includes a step of forming a joint between the second and third wing portions in which step at least one fastener is fastened between a wingskin support member of the first wing portion and a wingskin support member of the third wing portion.

4. An aircraft wing comprising:
(i) a first wing portion that, in use, forms an inner portion of an aircraft wing, and is attached to
(ii) a readily replaceable second wing portion comprising a wingtip, wherein
the wing is so arranged that the second wing portion is readily replaceable by a third wing portion comprising a wingtip, the third wing portion having a different functionality from the second wing portion, and the functionality of at least one of the second and the third wing portion being provided by one or more components contained within said at least one of the second and the third wing portion.

5. An aircraft wing according to claim 4 wherein each wing portion comprises an upper wingskin and a lower wingskin and is provided with a wingskin support member disposed between said upper and lower wingskins.

6. An aircraft wing according to claim 5 wherein a joint is formed by at least one fastener acting between the first wing portion wingskin support member and the second wing portion wingskin support member.

7. An aircraft wing according to claim 6, wherein the wingskin support member of the second wing portion comprises a peripheral flange adapted to receive said at least one said fastener.

8. An aircraft wing according to claim 4 wherein one or both of the first and second wing portions are provided with a seal member which, on attachment of the first wing portion to the second wing portion, forms a seal between said first and second wing portions.

9. An aircraft wing according to claim 4 wherein the first wing portion is attached to the second wing portion by a plurality of readily releasable fasteners.

10. An aircraft wing according to claim 9, wherein each wing portion comprises an upper wingskin and a lower wingskin and is provided with a wingskin support member disposed between said upper and lower wingskins and the fasteners are disposed around a periphery at least one of said wingskin support members.

11. An aircraft wing according to claim 10 wherein an end of at least one of said fasteners is captured within an enclosure of one of said support members.

12. An aircraft wing according to claim 4 in which at least one spigot is provided to locate the first wing portion with respect to the second wing portion.

13. An aircraft wing according to claim 4 wherein the first wing portion includes an inner wing rib comprising at least one rib foot and an outer wing rib comprising at least one rib foot and said rib foot of said outer wing rib is directed in a direction substantially opposite to said rib foot of said inner wing rib.

14. An aircraft wing according to claim 4, wherein the first wing portion is provided with at least one electrical connector for forming an electrical connection with a corresponding connector in the second or third wing portion.

15. A wing portion suitable for use as the first wing portion of the aircraft wing of claim 4.

16. A wing portion suitable for use as the second wing portion of the aircraft wing of claim 4.

17. An aircraft having an aircraft wing comprising:
(i) a first wing portion that, in use, forms an inner portion of an aircraft wing, and is attached to
(ii) a readily replaceable second wing portion comprising a wingtip, wherein
the wing is so arranged that the second wing portion is readily replaceable by a third wing portion comprising a wingtip, the third wing portion having a different functionality from the second wing portion, and the functionality of at least one of the second and the third wing portion being provided by one or more components contained within said at least one of the second and the third wing portion.

18. An aircraft according to claim 17, wherein the aircraft is a military transport aircraft.

19. An aircraft according to claim 17, wherein the aircraft has a length of greater than 10 metres, a wing span of greater than 10 metres and has a mass, when empty, of at least 10 tonnes.

20. A kit of aircraft parts comprising
(i) a first wing portion that, in use, forms an inner portion of an aircraft wing,
(ii) a second wing portion comprising a wingtip, the second wing portion being readily attachable to, and readily releasable from, the first wing portion, and
(iii) a third wing portion comprising a wingtip, the third wing portion being readily attachable to, and readily releasable from, the first wing portion,
wherein
the third wing portion has a different functionality from the second wing portion, and the functionality of the second wing portion is provided by one or more components contained within the second wing portion.
